(19) United States
(12) Patent Application Publication
(10) Pub. No.: US 2015/0209219 A1
(43) Pub. Date: Jul. 30, 2015

(54) BODY TREATMENT DEVICE

(71) Applicant: Yehezkel Hizko HEN, Lod (IL)

(72) Inventor: Yehezkel Hizko HEN, Lod (IL)

(21) Appl. No.: 14/595,356

(22) Filed: Jan. 13, 2015

(30) Foreign Application Priority Data
Jan. 29, 2014 (IL) IL23395

(51) Int. Cl. A61H 15/00; A61H 23/00

(52) U.S. Cl. CPC A61H 15/00; A61H 23/00

(57) ABSTRACT

A body treatment device (10) comprising: a foot platform (52) comprising at least one depression (48), shaped substantially to correspond to a foot (60) of a user, for placing a foot (60) in each of the at least one depression (48) while standing; a plurality of cylinders (12) disposed parallel to each other in the at least one depression (48), for placing the foot (60) thereon substantially in touch therewith; a first mechanism (38), for rotating the plurality of cylinders (12) along one direction at a time, against the foot (60); and a second mechanism for protecting a side of the foot (60) against pressure induced by the first mechanism (38), thereby rotation of the plurality of cylinders (12) against the foot (60), having significant weight of the standing, produces a mechanical linear pressure (64A, 64B) on a bottom surface (70) of the foot (60).

The current application claims the benefit of IL Patent application no. 229189 filed on 5 Aug. 2014, incorporated herein by reference.

### TECHNICAL FIELD

The present invention relates to the field of body treatment devices. In particular, the present invention relates to the devices treating the body through the foot.

### BACKGROUND ART

Reflexology claims that the spine and other organs may be treated through the bottom surface of the foot.

It is an object of the present invention to provide an apparatus for treating the body through the bottom surface of the foot. Other objects and advantages of the invention will become apparent as the description proceeds.

### SUMMARY OF THE INVENTION

A body treatment device (10) comprising:
a foot platform (52) comprising at least one depression (48), shaped substantially to correspond to a foot (60) of a user, for placing a foot (60) in each of the at least one depression (48) while standing;
a plurality of cylinders (12) disposed parallel to each other in the at least one depression (48), for placing the foot (60) thereon substantially in touch therewith;
a first mechanism (38), for rotating the plurality of cylinders (12) along one direction at a time, against the foot (60); and
a second mechanism for protecting a side of the foot (60) against pressure induced by the first mechanism (38),
   thereby rotation of the plurality of cylinders (12) against the foot (60), having significant weight of the standing, produces a mechanical linear pressure (64A, 64B) on a bottom surface (70) of the foot (60).

The first mechanism (38) may comprise:
a motor (44); and
a strap (66), for physically communicating the motor (44) with the plurality of cylinders (12),
   thereby the plurality of cylinders (12) are rotatable along a rotational direction of the motor (44).

The second mechanism for protecting a side of the foot (60) against pressure induced by the first mechanism (38), may comprise:
at least two extendible supporting members (50A, 50B), for titling the foot platform (52), for producing gravity force of the foot (60) being directed against the pressure induced by the first mechanism (38).

The body treatment device (10) may further comprise a control unit (20) for controlling the first and second mechanisms.

The body treatment device (10) may further comprise:
a handle (24), for allowing the user to hold by hands thereof.

The body treatment device (10) may further comprise:
a folding mechanism, for folding the handle (24) towards the foot platform (52).

Each of the plurality of cylinders (12) may comprise one or more protrusions (42) for preventing free slipping of the plurality of cylinders (12) along the bottom surface (70) of the foot (60).

Each of the plurality of cylinders (12) may be eccentric for preventing free slipping of the plurality of cylinders (12) along the bottom surface (70) of the foot (60).

The body treatment device (10) may further comprise:
a vibrator (46).

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 is a front view of a portion of a body treatment device according to one embodiment of the present invention.

FIG. 2 is a top view of three cylinders of FIG. 1.

FIG. 3 is a front view of the body treatment device of FIG. 1.

FIG. 4 is a front view of a portion of a body treatment device of FIG. 1, in operation of a first direction.

FIG. 5 is a front view of a portion of a body treatment device of FIG. 1, in operation of a second direction.

FIG. 6A depicts the cylinder of FIG. 1 according to one embodiment.

FIG. 6B depicts the cylinder of FIG. 1 according to another embodiment.

FIG. 7 is a perspective view of the body treatment device of FIG. 1.

FIG. 8 is a perspective view of the body treatment device of FIG. 1.

FIG. 9 is a perspective view of the body treatment device of FIG. 1 at a first folding step.

FIG. 10 is a perspective view of the body treatment device of FIG. 1 at the second folding step.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

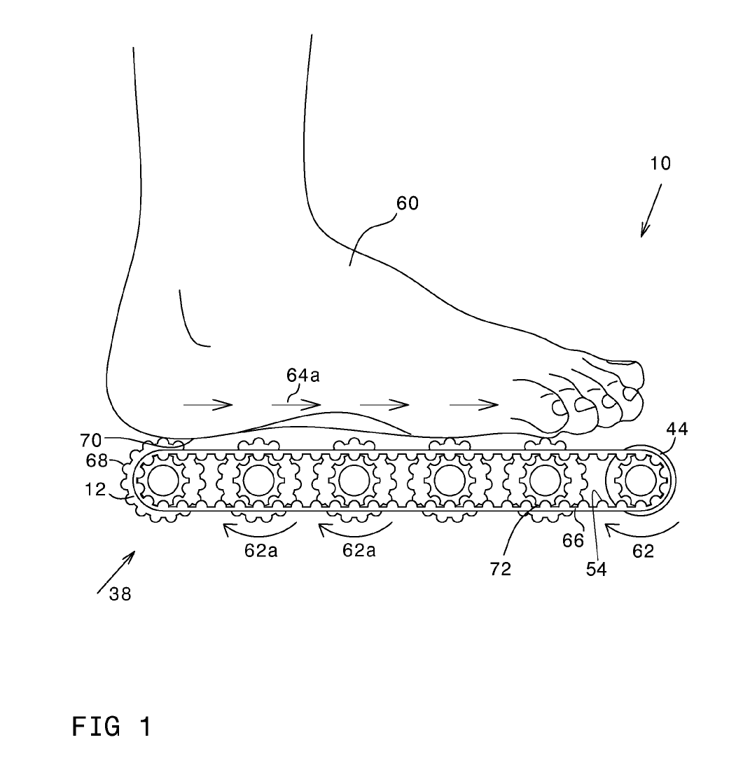

FIG. 1 is a front view of a portion of a body treatment device according to one embodiment of the present invention.

A body treatment device 10 includes a plurality of cylinders 12, disposed parallel one to the other, for being rotated by a mechanism 38 against the weight of a user's bear foot 60 standing thereon, substantially in touch therewith, bear or with socks.

Rotation of the external surfaces 68 of cylinders 12, all in the same angular direction, being angular direction 62A or against it, is intended for producing physical linear flow applied on the bottom surface 70 of foot 60, along linear direction 64A or against it. The physical flow may produce an internal blood flow, energy flow or other.

Mechanism 38 includes a motor 44, and may include a strap 66 having cogs 54 for transferring the rotation of motor 44 to cylinders 12, for rotating cylinders 12, all in the same angular direction 62A or against it.

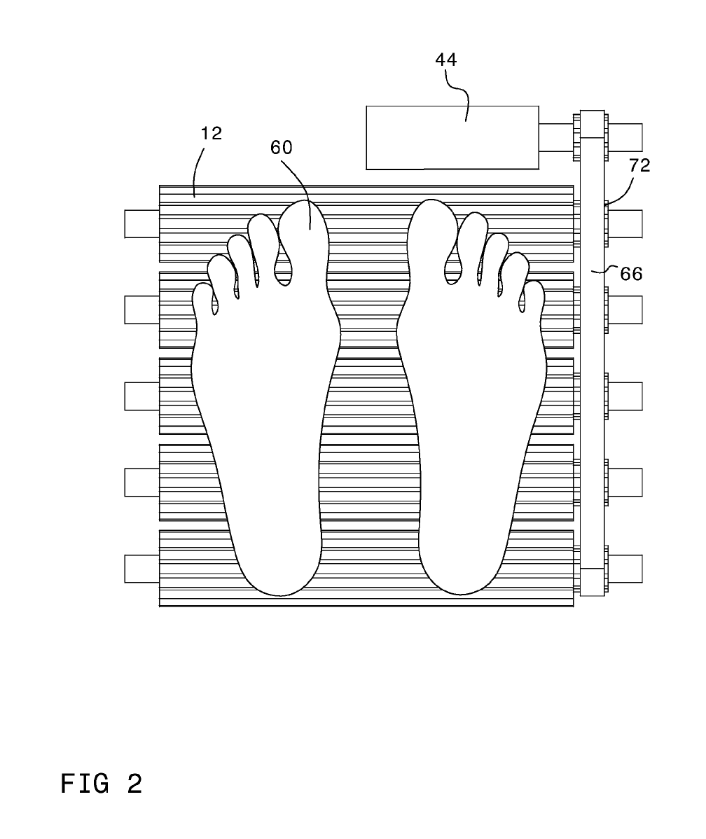

FIG. 2 is a top view of three cylinders of FIG. 1.

Each of cylinders 12 may include a gear 72, for being clasped by cogs 54 (enumerated in FIG. 1) of strap 66.

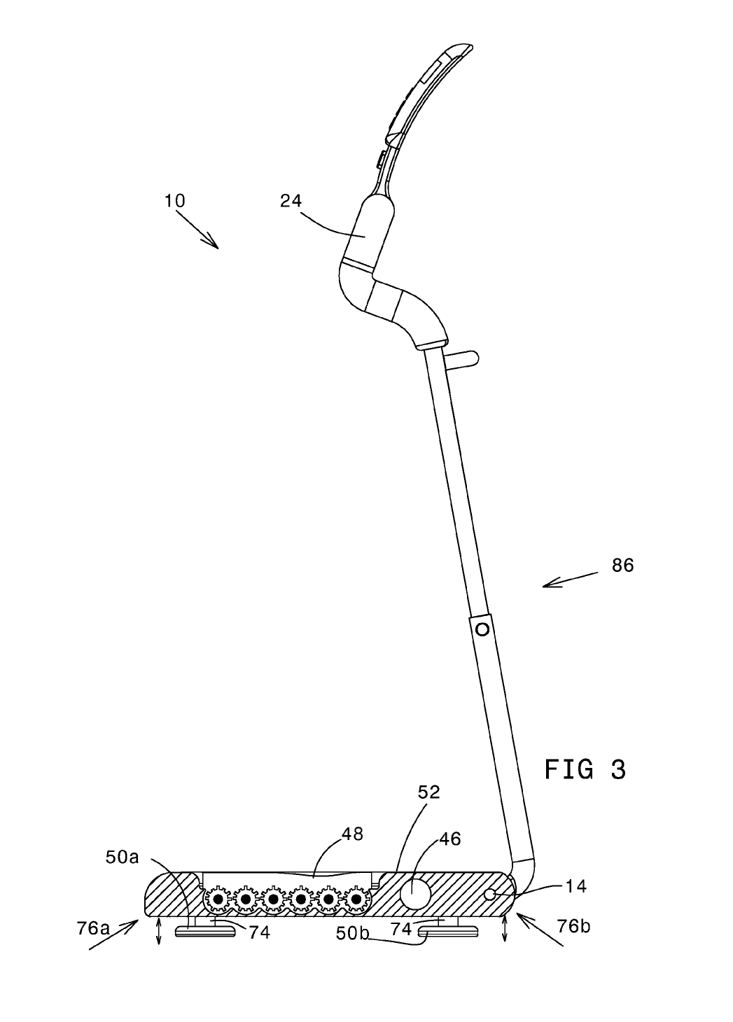

FIG. 3 is a front view of the body treatment device of FIG. 1.

Cylinders 12 are disposed within a platform 52 having one depression 48 for each foot. Depression 48 is disposed at the top, and the shape thereof is fitted to the shape of foot 60.

Platform 52 may further include a vibrator 46, for further vibrating the foot 60.

A rear extendible supporting member 50A supports the rear 76A of platform 52 to the ground; and a front extendible supporting member 50B supports the front 76B of platform 52 to the ground. Each of extendible supporting 50 includes a telescope 74, including hydraulic, pneumatic, or electric means for lifting the front 76 or the rear 78 of platform 52, one in relation to the other. This lifting of the front or the rear of platform 52 tilts the foot 60, and thus produces gravity force.

A handle 24 extends from platform 52 to the height of the hands of the user, for being held thereby. The base 86 of handle 24 may be rotated in relation to platform, through pivotal connection 14, either upon lifting the front 76 or the rear 78 of platform 52.

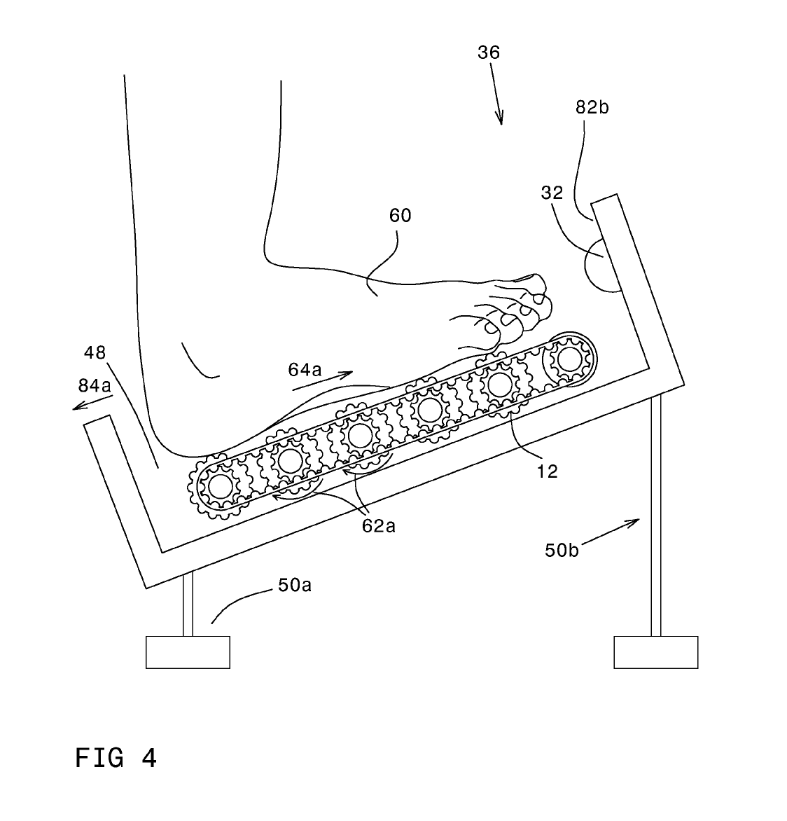

FIG. 4 is a front view of a portion of a body treatment device of FIG. 1, in operation of a first direction.

Upon rotation of cylinders along angular direction 62A which produces flow at the bottom surface 70 of foot 60, along linear direction 64A, the front of foot 60 might be pushed forward onto the front border 82B of depression 48. This pushing is not desirable, especially since the foot 60 is bear, thus might be hurt.

A protection mechanism 36 protects the front and the rear of the foot against pressure applied thereon. Protection mechanism 36 may include a padding 32 disposed on the front border 82B, and on the rear border 82A. According to another embodiment, protection mechanism 36 includes front extendible supporting member 50B.

A telescope 74 of front extendible supporting member 50B is being extended for lifting the front of foot 60 in relation to the rear, for producing gravity force 84A against the forward pushing.

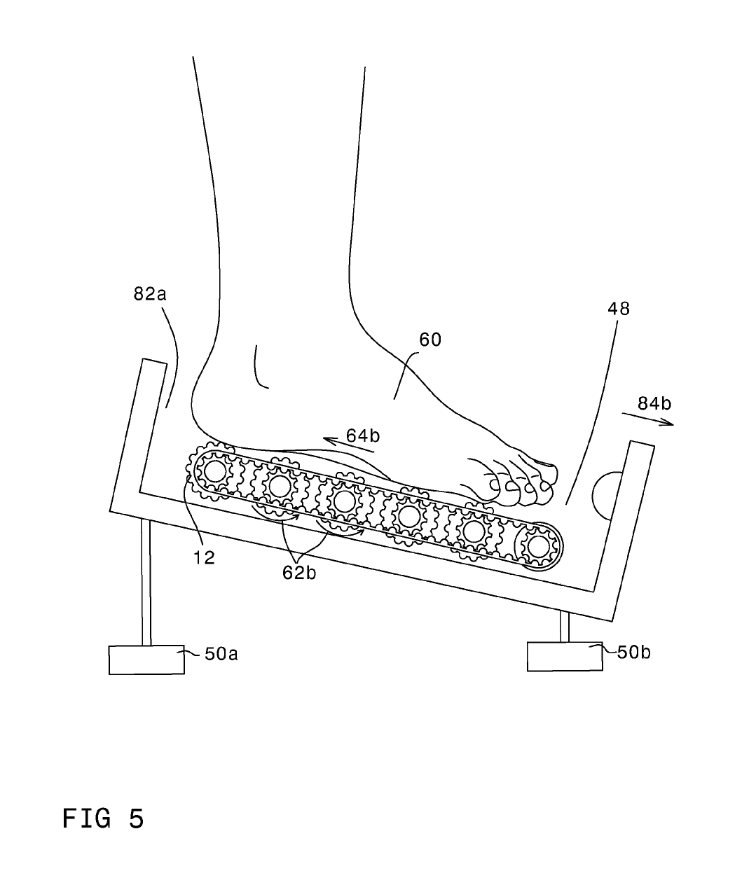

FIG. 5 is a front view of a portion of a body treatment device of FIG. 1, in operation of a second direction.

Upon rotation of cylinders along angular direction 62B which produces flow at the bottom surface 70 of foot 60, along linear direction 64B, the front of foot 60 might be pushed backward onto the rear border 82A of depression 48.

In order to avoid this pushing, telescope 74 of rear extendible supporting member 50A is being extended for lifting the rear of foot 60 in relation to the front thereof, for producing gravity force 84B against the rear pushing of cylinders 12

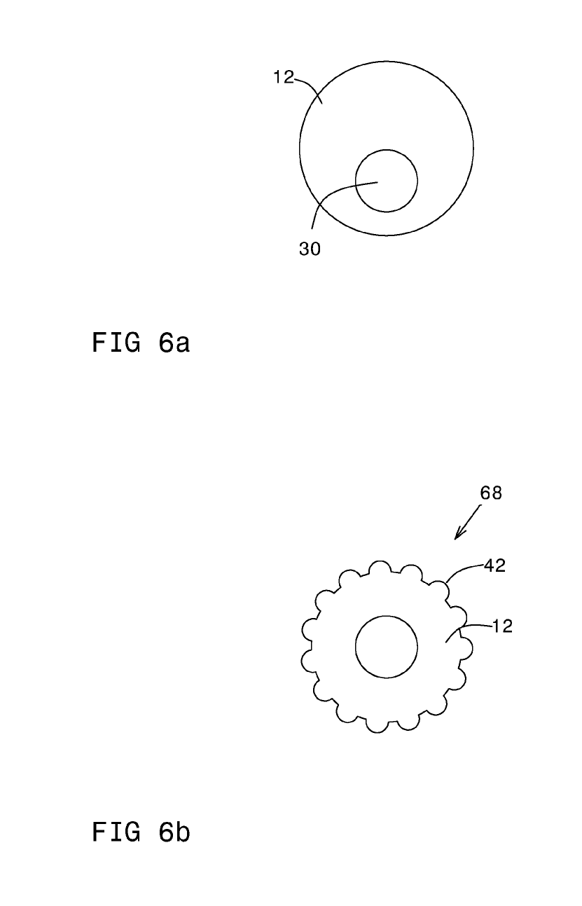

FIG. 6A depicts the cylinder of FIG. 1 according to one embodiment.

The external surface 68 of cylinder 12, contacting with bottom surface 70 of foot 60 may include one or more protrusions 42, for preventing free slipping of cylinder 12 along bottom surface 70 of foot 60, thus producing the linear physical pressure 64A or 64B on the bottom surface 70 of foot 60.

FIG. 6B depicts the cylinder of FIG. 1 according to another embodiment.

Cylinder 12 may have an axle 30 disposed away from the center, thus cylinder 12 is an eccentric cylinder, thus each roll of cylinder 12 produces a push on the bottom surface 70 of foot 60.

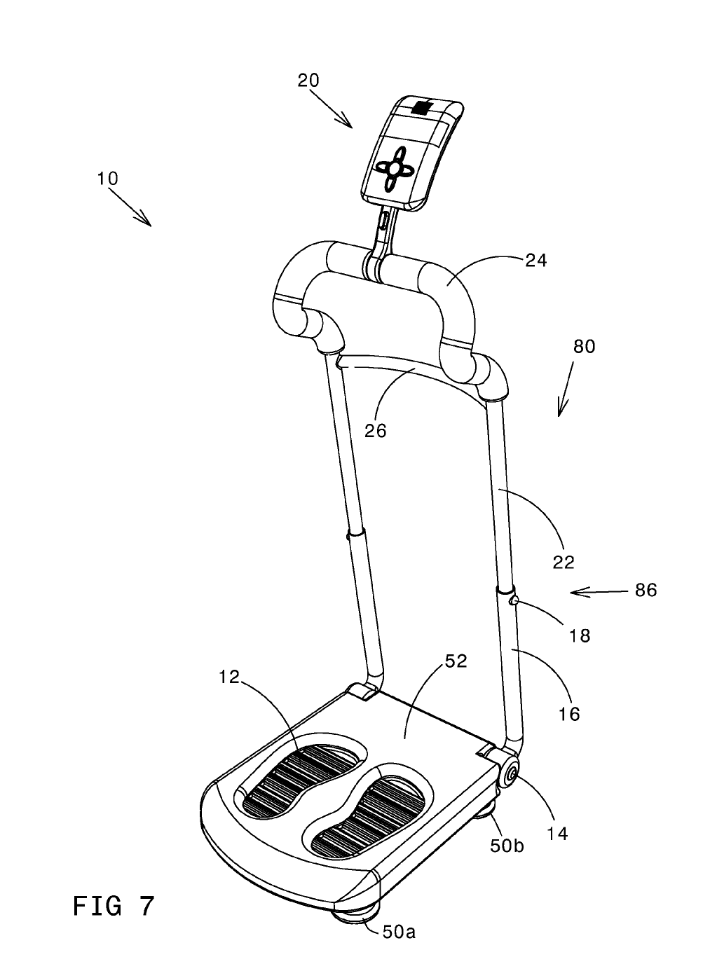

FIG. 7 is a perspective view of the body treatment device of FIG. 1.

Body treatment device 10 may include a folding mechanism 80, for folding handle 24 towards foot platform 52.

Folding mechanism 80 may include base 86 of handle 24 may include a bottom telescopic member 16; a top telescopic member 22; and a lock 18 in between.

A control unit 20 may controls motor 44 of FIG. 1 and controls the telescopes of supporting members 50A and 50B. Control unit 20 may be controlled manually, through a user interface, and/or automatically, such as through a timer.

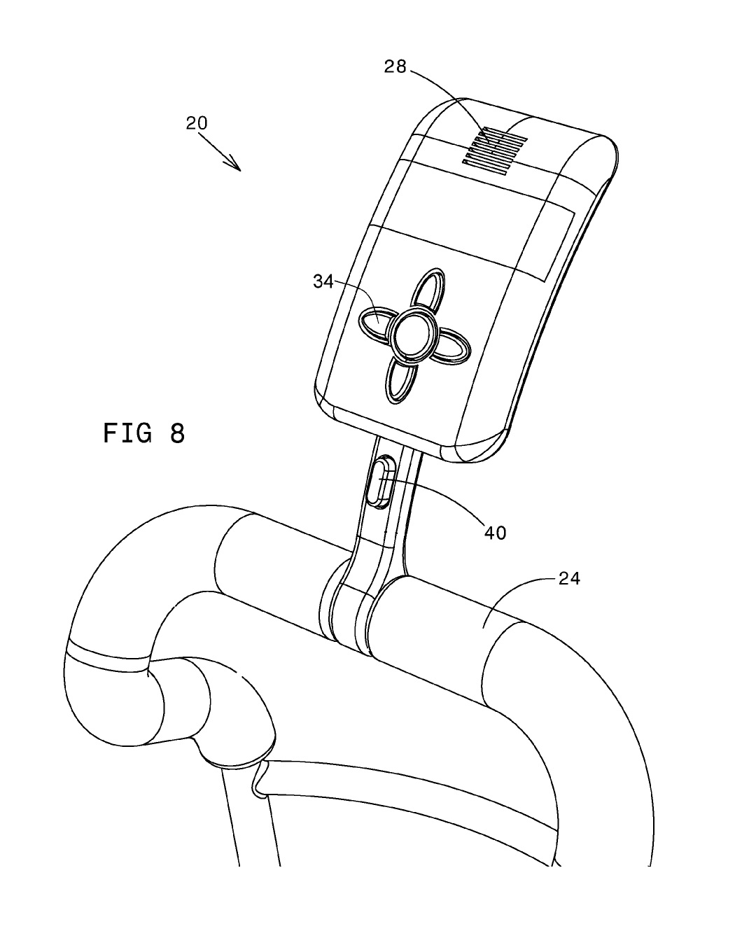

FIG. 8 is a perspective view of the body treatment device of FIG. 1. Control unit 20 may include a user interface including buttons 34, a speaker 28, etc.

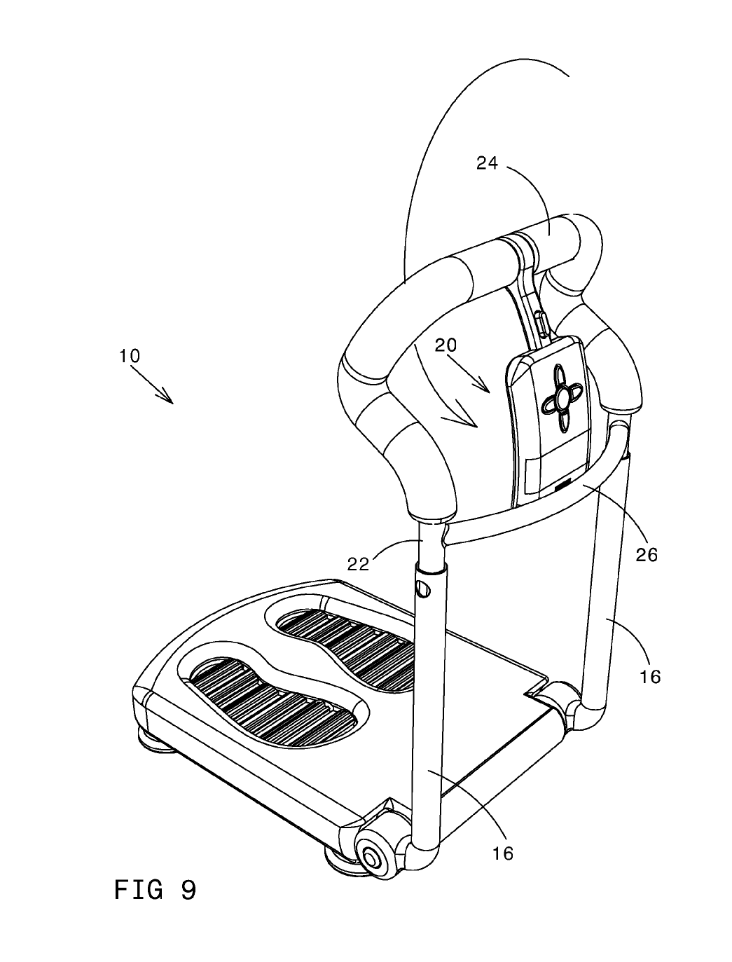

FIG. 9 is a perspective view of the body treatment device of FIG. 1 at a first folding step.

Thus, at the first step of folding, being opening lock 18, top telescopic member 22 may be inserted into bottom telescopic member 16. Also control unit 20 may be rotated by pressing physical button 40 (in FIG. 8).

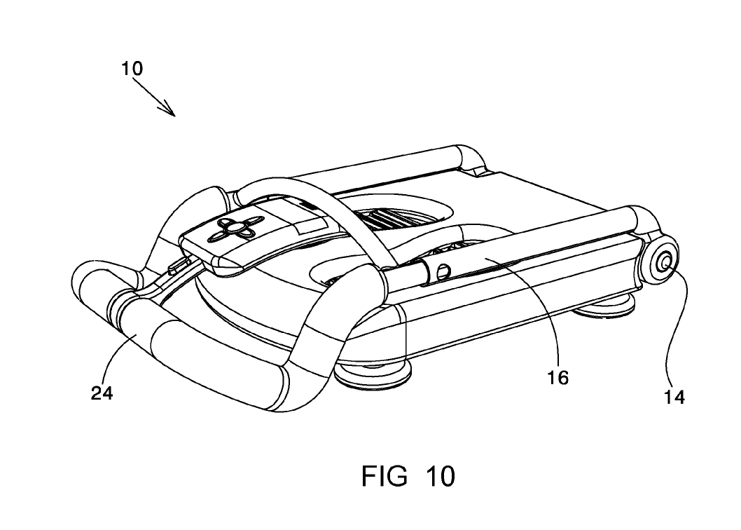

FIG. 10 is a perspective view of the body treatment device of FIG. 1 at the second folding step.

At the second folding step, pivotal connection 14 may be folded.

In the figures and/or description herein, the following reference numerals (Reference Signs List) have been mentioned:
numeral 10 denotes a body treatment device according to one embodiment of the present invention;
numeral 12 denotes a cylinder for producing physical flow on the bottom of the foot;
numeral 14 denotes a pivotal connection;
numeral 16 denotes a bottom telescopic member of the base of the handle;
numeral 18 denotes a lock, for not allowing folding the base of the handle;
numeral 20 denotes a control unit;
numeral 22 denotes a top telescopic member of the base of the handle;
numeral 24 denotes the handle;
numeral 26 denotes a bar;
numeral 28 denotes a speaker;
numeral 30 denotes an axle of the cylinder;
numeral 32 denotes a padding;
numeral 34 denotes a button;
numeral 36 denotes a protection mechanism, for protecting the front and the rear of the foot against pressure applied thereon;
numeral 38 denotes a mechanism for rotating the cylinders along one direction against the weight applied thereon by the foot;
numeral 40 denotes a physical button;
numeral 42 denotes a protrusion in the cylinder;
numeral 44 denotes a motor for rotating the cylinders;
numeral 46 denotes a vibrator;
numeral 48 denotes a depression having the shape of the foot, for placing the foot therein;
numeral 50A denotes a rear extendible supporting member, for supporting and lifting the rear portion of the platform;
numeral 50B denotes a front extendible supporting member, for supporting and lifting the front portion of the platform;
numeral 52 denotes the platform, on which the user stands;
numeral 54 denotes a cog of the strap;
numeral 60 denotes a foot of the user;
numeral 62A denotes an angular motion of the wheel;
numeral 62B denotes the angular motion opposite to angular motion 62A;
numeral 64A denotes a linear pressure produced on the bottom surface of the foot by the angular motion 62A of the wheel;
numeral 64A denotes a linear pressure produced on the bottom surface of the foot by the angular motion 62B of the wheel;
numeral 66 denotes a strap, for transferring the rotation of the motor to the plurality of wheels;
numeral 68 denotes an external surface of the cylinder;
numeral 70 denotes the bottom surface of the foot;
numeral 72 denotes a gear or another surface of the cylinder, receiving the motion of the motor;
numeral 74 denotes a telescope of the supporting member;
numeral 76 denotes the rear portion of the platform;
numeral 78 denotes the front portion of the platform;
numeral 80 denotes a folding mechanism;
numerals 82A and 82B denote rear and front borders of the depression of the foot platform;
numeral 84A denotes gravity force applied on the foot pressing the foot backward;
numeral 84B denotes gravity force applied on the foot pressing the foot forward; and
numeral 86 denotes the base of the handle, for extending the handle from the foot platform.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A body treatment device (10) comprising:
a foot platform (52) comprising at least one depression (48), shaped substantially to correspond to a foot (60) of a user, for placing a foot (60) in each of said at least one depression (48) while standing;
a plurality of cylinders (12) disposed parallel to each other in said at least one depression (48), for placing said foot (60) thereon substantially in touch therewith;
a first mechanism (38), for rotating said plurality of cylinders (12) along one direction at a time, against the foot (60); and
a second mechanism for protecting a side of the foot (60) against pressure induced by said first mechanism (38),
thereby rotation of said plurality of cylinders (12) against the foot (60), having significant weight of the standing, produces a mechanical linear pressure (64A, 64B) on a bottom surface (70) of the foot (60).

2. A body treatment device (10) according to claim 1, wherein said first mechanism (38) comprises:
a motor (44); and
a strap (66), for physically communicating said motor (44) with said plurality of cylinders (12),
thereby said plurality of cylinders (12) are rotatable along a rotational direction of said motor (44).

3. A body treatment device (10) according to claim 1, wherein said second mechanism for protecting a side of the foot (60) against pressure induced by said first mechanism (38), comprises:
at least two extendible supporting members (50A, 50B), for titling said foot platform (52), for producing gravity force of the foot (60) being directed against said pressure induced by said first mechanism (38).

4. A body treatment device (10) according to claim 1, further comprising a control unit (20) for controlling said first and second mechanisms.

5. A body treatment device (10) according to claim 1, further comprising:
a handle (24), for allowing the user to hold by hands thereof

6. A body treatment device (10) according to claim 5, further comprising:
a folding mechanism, for folding said handle (24) towards said foot platform (52).

7. A body treatment device (10) according to claim 1, wherein each of said plurality of cylinders (12) comprises one or more protrusions (42) for preventing free slipping of said plurality of cylinders (12) along the bottom surface (70) of the foot (60).

8. A body treatment device (10) according to claim 1, wherein each of said plurality of cylinders (12) is eccentric for preventing free slipping of said plurality of cylinders (12) along the bottom surface (70) of the foot (60).

9. A body treatment device (10) according to claim 1, further comprising:
a vibrator (46).
